(19) United States
(12) Patent Application Publication
(10) Pub. No.: US 2005/0170281 A1
(43) Pub. Date: Aug. 4, 2005

(54) Method of cleaving labile functional groups from chemical compounds

(76) Inventor: Klaus-Peter Stengele, Pleiskirchen (DE)

Correspondence Address: GRAYBEAL, JACKSON, HALEY LLP, 155 - 108TH AVENUE NE, SUITE 350, BELLEVUE, WA, 98004-5901, US

(21) Appl. No.: 11/019,938

(22) Filed: Dec. 21, 2004

(30) Foreign Application Priority Data
Jun. 21, 2002 (DE) 102 27 814.8
Jun. 23, 2003 (WO) PCT/EP03/06588

(51) Int. Cl. G03C 1/76

(52) U.S. Cl. 430/270.1

(57) ABSTRACT

The present invention provides a method of cleaving labile functional groups from molecules by exposure to electromagnetic radiation in which the molecules are contacted with a chemical compound whose triplet state is energetically higher than the triplet state of the labile functional group and are then exposed to electromagnetic radiation, with the labile functional group and the suitable chemical compound having different absorption maxima for electromagnetic radiation. Further, the invention provides a method of manufacturing DNA chips by spatially addressed, light-controlled nucleotide synthesis on solid substrates. In addition, the present invention provides a chemical composition comprising a molecule with a labile functional group and a chemical compound whose triplet state is higher than the triplet state of the labile functional group, with the labile functional group and the chemical compound having different absorption maxima for electromagnetic radiation, and describes the use of the chemical composition in the manufacture of DNA chips.

A method of cleaving labile functional groups from chemical compounds The present invention relates to a method of cleaving labile functional groups from molecules by exposure to electromagnetic radiation and a method of manufacturing DNA chips by spatially addressed, light-controlled nucleotide synthesis on solid substrates, further a chemical composition and the use of said chemical composition to produce DNA chips.

Easy cleavage of functional groups from molecules plays an important role in many fields of chemistry and biology, like for example in the synthesis of larger chemical units from building blocks such as in the synthesis of polymers, natural substances, etc.. In this process, highly reactive groups of building blocks, which may impair the respective intended linking of two molecules or interfere as a result of undesired secondary reactions are “masked” selectively or protected temporarily and reversibly by functional protective groups to avoid their participation during polymer synthesis.

The use of large combinatorial libraries of binding partners immobilized on a substrate of biomolecules provided in solution is very advantageous in the comparative study of molecular recognition of biomolecules of the same or different structural classes.

Those skilled in the art use the term “biomolecules” to refer to compounds of the classes comprising nucleic acids and their derivatives including (DNA, RNA, LNA, PLA, and chimeras thereof, proteins, peptides and carbohydrates.

This principle of mutual molecular recognition is primarily used in the selective synthesis of polynucleotides from nucleoside and/or oligonucleotide building blocks. Selective polynucleotide synthesis in turn is of critical importance for the manufacture of chips with a high density of polynucleotides arranged thereon (high-density DNA chips).

DNA chips, i.e. so-called microarrays of spots of DNA or of any selected oligonucleotide immobilized on glass or polymer substrates, which act as super multiplex probes for molecular recognition by hybridization (S. P. A. Fodor, Science 277 (1997) 393, DNA Sequencing Massively Parallel Genomics), have already been in use in the fields of medical research and pharmaceutical research for a long time.

There again, DNA chips play an important role in genetic analysis and diagnosis. So-called spatially addressed, parallel, light-controlled oligonucleotide synthesis on solid substrates (see e.g. S. P. A. Fodor et al., Nature 364 (1993), 555, Multiplexed Biochemical Arrays with Biological Chips) using photolabile protective groups, i.e. protective groups for reactive functionalities of the nucleoside or nucleotide building blocks, which can selectively cleaved, primarily by the use of UV light of a certain wavelength, for the protected functionalities to be available again for further reactions, forms the most widely used technique of manufacturing said DNA chips.

DNA chips are manufactured by using the above-mentioned technique referred to as photolithography. In this technique, synthesis of the desired oligonucleotide chains on the substrate is controlled by suitable labile protective groups which release the connection site for the next nucleotide upon exposure (primarily using electromagnetic radiation in the UV/VIS range) for example. Until now, these protective groups have preferably been photolabile. These photolabile protective groups can be used to develop a combinatorial strategy by means of spatial, selective exposure that produces extremely dense, spatially addressable microarrays of oligonucleotides whose number grows exponentially as the number of synthesis cycles (split and pool) increases. The currently achievable surface area of each element of less than 50 μm² can theoretically accommodate more than 10⁶ probe fields in 1 cm². One method was performed by means of micromirror arrays (S. Singh-Gasson et al., Nature Biotechn. 17 (1999) 974, Maskless Fabrication of Light Directed Oligonucleotide Microarrays using a Digital Micromirror Array), like those used in digital projection technology. This avoids time-consuming and expensive fabrication of exposure masks and makes it possible to manufacture DNA chips more rapidly by means of photolithography.

Currently used photolabile protective groups still do not yield satisfactory results with respect to the error rate of DNA chips synthesized in this manner (D. J. Lockheart and E. A. Winseler, Nature 405 (2000) 827, Genomics, Gene expression and DNA arrays). The cleavage of protective groups is not complete enough, as these groups often only exhibit a low capacity for absorbing the UV/VIS wavelengths used. Beyond that, partially excited or fully excited protective groups lead to interfering secondary reactions with undesired reaction products, to the effect that the bulk of oligonucleotides on the DNA chips cannot be used.

A central point in photolithographic synthesis consists of the use of photolabile protective groups employed in many chemical variations in organic chemistry and bioorganic chemistry (V. N. R. Pillay, Photolythic Deprotection and Activation of Functional Groups, in: Organic Photochemistry, Vol. 9 ed. A. Padwa (Marcel Dekker, New Yord and Basel, 1987), page 225 and following). The most widely used photolabile protective groups are those based on the 2-nitrobenzyl group (J. E. T. Correy and E. R. Trenton, Caged Nucleotides and Neurotransmitters, in: Biological Applications of Photochemical Switches, in: Bioorganic Photochemistry Series, Vol. 2 ed. Harry Morrison (Wiley Interscience, 1993) page 243 and following).

Until now, the MeNPOC (α-methylnitropiperonyloxycarbonyl) protective group, which is among the standard protective groups in DNA chip fabrication, has been preferred among the protective groups of the 2-nitrobenzyl type in the manufacture of DNA chips, for example when protecting the terminal 5′ OH group during oligonucleotide synthesis from the 3′ to the 5′or from the 5′ to the 3′ terminus (S. P. A. Fodor et al., Science 251 (1991), 767, Light Directed, Spatially Addressable Parallel Chemical Synthesis).

The disadvantage of this type of protective group lies in the formation of an aromatic nitrosoketone, a very reactive leaving group, after cleavage. This leads to undesired subsequent reactions which often cause errors in the nucleotide structure of the resulting oligonucleotide or polynucleotide.

Most currently known photolabile protective groups require irradiation with the 365 nm line of a mercury lamp for of several minutes under common radiation strengths for a quantitative reaction.

Beyond that, 2-(2-nitrophenyl) ethoxycarbonyl compounds, in which the protective groups are cleaved as 2-nitrostyrene derivatives, are known in the manufacture of DNA chips (DE-PS 44 44 996, DE-PS 196 20 170 and U.S. Pat. No. 5,763,599). The separation of 2-nitrostyrenes which are generally less reactive also makes these compounds less prone to interfering secondary reactions than the compounds mentioned above, but still require 365 nm irradiation.

Thus, the object of the present invention is to provide a method for decreasing the cleavage reaction rate of labile groups for optimizing the yield of the cleavage reaction. A further object is to reduce the risk of undesired secondary reactions occurring during cleavage of the labile protective group. Yet another object is to decrease generic damage of the generated DNA by the high-intensity short wavelength UV irradiation.

The above-mentioned object of the present invention is solved by a method of separating labile functional groups from molecules comprising the following steps:
a) Selecting a suitable chemical compound whose triplet state is energetically higher than or very similar to the triplet state of the labile functional group;
b) Bringing the chemical compound into contact with the molecules comprising the labile functional groups;
c) Exposing the compound to electromagnetic radiation, with the sequence of steps b) and c) being arbitrary;
and wherein the labile functional group and the suitable chemical compound have different absorption maxima for electromagnetic radiation. Preferably, the electromagnetic radiation is in the long-wavelength UV region. The long-wavelength UV absorption maxima of the labile functional group and of the suitable chemical compound differ at least by 10, preferably by more than 20, most preferably by more than 30 nm to 50 nm.

The irradiation induces the excitation of the singlet state (SI) of the selected suitable chemical compound to its triplet state (TI) and the electromagnetic radiation absorbed by the selected chemical compound is transferred via a triplet-triplet transition to the labile functional group which can then be efficiently and rapidly cleaved. The labile functional group and the suitable chemical compound exhibit different absorption maxima for electromagnetic radiation, i.e. in the most preferred embodiment of the invention. It is understood that the scope of the invention comprises also a selection of chemical compound and labile functional groups whose absorption maxima, albeit different from one another will lead to at least a partial excitation of the functional groups. Only the suitable chemical compound, but not the labile functional group, is excited as a result of the electromagnetic irradiation.

Although the triplet-triplet transition and thus the amount of energy to be transferred is even more efficient due to the different energy gaps of the two compounds than direct excitation of the labile groups without sensitizer, undesired secondary reactions are advantageously avoided. The latter always occur in prior art methods because, if the labile functional group has the same absorption maximum or a similar one as the sensitizing compound, a portion of the labile functional groups present is also excited by electromagnetic irradiation. The irradiation, however, is not sufficient to provide a transition into the triplet state and will therefore cause a variety of undesired secondary reactions in the partially excited state such as decay, intramolecular and/or intermolecular rearrangement, etc.. In the present invention, it makes no difference whether the method is performed in solution or in a solid phase, like for example on a solid substrate on which the molecules containing the labile functional groups are applied. Thus, the method is well suited for a variety of reactions such as the synthesis of oligonucleotides, oligopeptides and other oligomers or polymers, where a number of undesired secondary reactions often occur and have to be avoided and especially well suited for DNA analogues that are itself not stable to the 365 nm irradition as used in prior art.

The term, “very similar triplet state”, as used herein refers to the fact that “very similar” comprises a range of energy comprising the triplet state of the suitable chemical compound near the triplet state which is a multiple n of the mean thermal energy RT with an order of magnitude of approx. 2.5 kJ of the triplet state of the functional group, where n=8, preferably 4.

The term “labile” as used herein means that the labile group can be cleaved from the molecule upon external delivery of any sort of energy sufficient to cleave the bond between the functional group and the molecule. Therefore, the labile group may be photolabile, thermolabile etc. or not photolabile or thermolabile. It should be noted that the labile group and the remaining molecule are thermodynamic and/or kinetic stable entities without or after a rearrangement reaction following bond cleavage.

The bringing in contact is performed by methods known to those skilled in the art, e.g. by rinsing a chip surface with a solvent containing a suitable chemical compound etc. In an especially advantageous embodiment for both compounds, i.e. the molecules with the labile functional groups and the chemical compound of the present invention (also referred to as “sensitizing compound”), are present in the same phase.

Depending on the selection of the functional protective group and the respective sensitizing compound, their absorption maxima for electromagnetic radiation is determined by common techniques. The knowledge of the respective absorption maxima enables a specific selection of the respective wavelength of electromagnetic radiation from the electromagnetic wavelength spectrum.

The cleavage can also be achieved if only the sensitizing compound is activated either by electromagnetic radiation prior to bringing it in contact with the chemical compound, i.e. with a sequence of steps c)-b) of the method according to the present invention or by separating the respective absorption bands far enough. The sensitizing compound then transfers its triplet energy very efficiently to the functional protective group. Advantageously, this results in that even molecules with functional protective groups that are otherwise unsuitable for reactions of this kind and would be destroyed, for example, by electromagnetic radiation of a defined wavelength initiating a cleavage, or that would initiate a variety of undesired subsequent reactions (rearrangements etc.), can be subjected to a cleavage reaction. This is achieved by selection of the suitable sensitizing compound and irradiation with an uncritical selected wavelength that does not destroy the molecules. The specific irradiation only activates the sensitizing compound that transfers this energy via a triplet-triplet transfer to radiation-sensitive molecules, so that the functional groups can still be cleaved just the same. Compounds which are labile and prone to degradation upon irradiation with usual methods can advantageously used within the present invention. For example, 5-bromo-deoxy-uridine, and its protected derivatives, a DNA analogue, are useful in the so-called Photoaptamer-technique as a crosslinker to biomolecules upon UV-irradiation. These compounds degrade upon irradiation with a wavelength of 365 nm, i.e. that of a currently used Hg lamp. However, at 400 nm 5-bromo-deoxy-uridine and its protected derivatives are stable but cannot be deprotected by the methods in prior art. Upon addition of a sensitizer according to the invention, e.g. a thioxanthone derivative like 2-chlorothioxanthone, deprotection at 400 nm by use of a Xenon lamp is feasible. Further, the sensitizing compound can also be activated by preliminary radiation from a laser or other high-energy radiation such as X-ray radiation, electron radiation or particle radiation, e.g. X-radiation or y-radiation. In another advantageous embodiment, steps b) and c) can also be carried out simultaneously.

More preferably, the electromagnetic radiation has a wavelength which is in the range of the absorption maximum, i.e. that of the longest wavelength electronic transition of the sensitizing compound to make sure that only the suitable chemical compound is excited, but not the labile functional group. Thus, undesired secondary reactions of the partially or completely excited labile functional group are avoided, which results in a more efficient transfer of energy from the suitable excited chemical compound to the labile functional group, thereby increasing the cleavage reaction rate and improving yield due to the lack of undesired subsequent reactions. As an additional advantage, the need for possibly required purification steps of the desired main reaction product contaminated by reaction products of undesired secondary reactions is eliminated.

It is preferable for the labile group to be photolabile so that the method of the present invention is especially easy to apply, for example, in known procedures of manufacturing DNA (including RNA, LNA and PLA and chimeras thereof), protein, and peptide chips. Not only that, the method of the present invention can also be used advantageously in photoinduced polymerization reactions in classical polymer chemistry or in polymerization reactions induced by electromagnetic radiation of other wavelengths such as IR. For the purpose of the manufacture of oligonucleotide or peptide chips, the electromagnetic radiation is preferably in the wavelength range of UV/VIS radiation (210-650 nm). Accordingly, the method of the present invention can be employed, for example, in the manufacture of DNA chips and peptide chips using conventional mercury or Xenon lamps. Of course, other suitable sources of light known to those skilled in the art can also be used in the present invention.

It is especially advantageous for the singlet state of the chemical compound to be lower than the singlet state of the labile functional group. Under these conditions, the wavelength and therefore the energy of the incoming light can be shifted to a specific range, i.e. a so-called “window” of the electromagnetic spectrum in which the unwanted secondary reactions to be expected, particularly in the manufacture of DNA chips, can be minimized further.

It is especially preferred that the triplet-singlet energy gap of the chemical compound be smaller than the triplet-singlet energy gap of the labile functional group. Furthermore, the chemical compound preferably exhibits a high triplet formation quantum yield DT near the maximum possible magnitude of 1.

In a further preferred embodiment the absorption bands of the suitable chemical compound and of the labile functional group are separated. This means that their absorption bands do not overlap.

The object of the present invention is further solved by a method of manufacturing molecular libraries containing biomolecules, in particular for the manufacture of DNA chips and peptide chips, as well as their analogues and mimetics, by spatially addressed, light-controlled synthesis on solid substrates comprising the following steps:
a) Reaction of the unprotected terminal 3′ or 5′ hydroxy group of a nucleoside and/or nucleotide or a nucleic acid analogue or a —COOH or amino group of a suitable peptide arranged on the solid substrate under common conditions essentially known to those skilled in the art with a photolabile protective group or reaction of an —OH group, —COOH group, —NHR group, wherein R can be H, alkyl, aryl, aralkyl with a building block comprising a photolabile protective group, and, if necessary, purification of the reaction product;
b) Application of a chemical compound (sensitizing compound) whose triplet state is energetically higher than or very similar to that of the photolabile protective group on the surface of the substrate which exhibits the nucleotides and/or nucleosides or nucleic acid analogues or peptides or peptide mimetics modified in step a);
c) Spatially selective irradiation of the substrate surface treated in step b) with electromagnetic radiation in the UV/VIS range;
d) Reaction with a nucleoside and/or nucleotide in which a free 5′ or 3′ OH group is protected by a photolabile group or reaction with a corresponding suitable peptide or amino acid;
e) If necessary, repetition of steps b) to d) and
wherein the photolabile protective group and the sensitizing compound have different absorption maxima for electromagnetic radiation in the UV/VIS range.

The application of the chemical compound is performed by common methods such as rinsing, knife coating, spraying, spray-painting, applying by dropping, etc. where the chemical compound is added in the pure state, in solution, in suspension or in the form of a dispersion.

The photolabile protective group and the sensitizing compound have different absorption maxima for electromagnetic radiation, i.e. in the most preferred embodiment only the sensitizing compound, but not the photolabile protective group, is excited by the electromagnetic radiation. At different absorption maxima of the sensitizing compound and the photolabile protective group, the triplet-triplet transition is even more efficient due to the different energy gaps. Therefore, undesired secondary reactions which occur when the sensitizing compound and the photolabile protective group have the same or similar absorption maxima are advantageously avoided. These secondary reactions occur because a portion of the labile functional groups present is excited by the electromagnetic radiation, but does not change into the triplet state and, in the excited state, can cause a variety of undesired secondary reactions such as decay, intramolecular rearrangement and intermolecular rearrangement, etc.. For the purpose of the present invention, it makes no difference whether the method is performed in solution or in a solid phase, like for example on a solid substrate on which the molecules containing the photolabile protective groups are applied.

Of course, this method is also suitable for the synthesis of polypeptides and other molecules.

More preferably, the electromagnetic radiation has a specifically selected wavelength which is in the range of the absorption maximum of the sensitizing compound to ensure even more effectively that only the sensitizing compound is excited, but not the photolabile protective group.

Most preferably, the absorption maximum is that of the longest wavelength electronic transition. Still more preferred, this absorption maximum is in the region of wavelengths of longer than 350 nm, more preferred of longer than 375 nm. As a result, undesired secondary reactions of the partially or completely excited labile functional group are avoided, which results in a more efficient transfer of energy from the sensitizing compound to the photolabile protective group, thereby increasing the reaction rate and improving the yield due to the lack of undesired subsequent reactions. As an additional advantage, the need for possibly required purification steps due to contamination of the desired main reaction by reaction products from undesired secondary reactions is eliminated.

Furthermore, the object of the present invention is solved by providing a chemical composition comprising a molecule with a labile functional group and a suitable chemical compound whose triplet state is energetically higher than or very similar to the triplet state of the labile functional group, with the labile functional group and the suitable chemical compound having different absorption maxima for electromagnetic radiation.

The combination of two different compounds with different absorption maxima and triplet states, with one triplet state being higher than or very similar to the other triplet state, allows for the transfer of triplet excitation energy with almost no loss from one compound to the labile functional group. The labile functional group takes up the energy and is then more easily cleaved without the need to be excited itself by electromagnetic radiation. The composition of the present invention is preferably used in one of the above-mentioned methods according to the present invention, thus making execution of same more efficient and easier.

Preferably, the functional group is a photolabile group, however, all other groups which are labile upon contact to an excited Triplet state sensitizer molecule can be used as well.

It is preferable for the labile group and it is especially preferable for the photolabile group to be selected from the group consisting of NPPOC, MeNPOC, MeNPPOC, DMBOC, NPES, NPPS and their substituted derivatives, substituted and unsubstituted, condensed and uncondensed 2-(nitroaryl) ethoxycarbonyl or thiocarbonyl compounds, substituted and unsubstituted, condensed and uncondensed 2-nitrobenzyl, 2-nitrobenzyloxycarbonyl or thiocarbonyl compounds, substituted and unsubstituted, condensed and uncondensed 2-(nitroheterocycloaryl) ethoxycarbonyl or thiocarbonyl compounds and substituted and unsubstituted, condensed and uncondensed 2-(nitroheterocycloalkyl) ethoxycarbonyl/thiocarbonyl compounds, substituted and unsubstituted 2-nitro-N-methylanilinecarbonyl or thiocarbonyl derivatives.

Preferably, the chemical compound contains the structural motive, 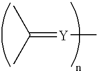
wherein Y=O, S, N, Se or Te, n=1 or 2, C is a part of an aromatic, heteroaromatic or condensed aromatic or heteroaromatic system, and wherein the aromatic, heteroaromatic or condensed aromatic or heteroaromatic system can be the same or different if n=2.

The presence of one or more conjugated n systems or more than two conjugated double bonds is particularly advantageous. The use of benzophenone and thioxanthone derivatives is especially preferred.

The structural motive of the present invention allows for effective intersystem crossing in the triplet state, a long triplet lifetime of more than 0.6 microseconds (es), in particular of more than 1 microsecond (its). Beyond that, it causes the chemical compound in the triplet state to be largely chemically stable so that the compound in the triplet state is very unreactive.

Of course, the chemical compound of the present invention can be used both alone and in the form of an excited or unexcited dimer, oligomer, multimer, associate or complex with compounds comprising an element of the periodic table, preferably a metal or a metalloid. It goes without saying that a combination of two or more different compounds of the present invention may be used without leaving the scope of the invention.

Preferably, solutions comprising 0.001 to 5 weight percent (based on the solvent used), more preferably 0.005 to 0.05 weight percent of the chemical compound of the present invention (based on the solvent used), are employed, if the labile functional group is attached to a solid surface. Higher concentrations are preferred for a solution phase process and are usually in the range of more than 0.5%.

If the amount of the chemical compound according to the present invention exceeds 5 weight percent, chemical reactions occur with the molecule comprising the functional group, particularly during synthesis of oligonucleotides and DNA sequences, and may destroy the molecule comprising the functional group. Therefore, lower concentrations should usually be preferred. Those skilled in the art can readily determine the exact selection of the suitable concentration by means of a few preliminary experiments.

The chemical composition according to the present invention is preferably used for the manufacture of oligonucleotides, for example DNA chips, by a light-controlled method known to those skilled in the art as they have been explained, for example, in the introduction, as this represents a simple way to enable the transfer of energy between the triplet state of the sensitizing compound and the photolabile protective group so that the photochemical separation reaction can be initiated particularly quickly and completely. Oligonucleotide synthesis may, of course, be performed both in solution and on a solid substrate, for example a known chip substrate.

The term “nucleotide” as used herein refers to polynucleotides with 2 to 10 nucleosides which are connected to each other by 3′-5′ and/or 5′-3′ phosphoric acid ester linkages. However, the nucleotides of the present invention also comprise polynucleotides with more than 10 nucleoside building blocks.

The methods of the present invention are not just suitable for DNA and RNA nucleotide synthesis. Naturally, polynucleotides can also be synthesized from nucleic acid analogues such as PNA, LNA or their chimeras with DNA, RNA or nucleic acid analogues in solution and on a substrate or a chip. Beyond that, they can also be used to produce polypeptides.

The methods of the present invention are especially suitable for use in an automated procedure. Preferably, this kind of automated procedure is designed as a parallel synthesis in solution or on a substrate to form a nucleotide library in which the chemical compounds or labile protective groups used can be selected deliberately or at random.

In another embodiment, the present invention comprises a kit that contains a portion of or all of the reagents and/or adjuvants and/or solvents and/or instruction for performing one of the methods of the present invention in a spatial unit, with the kit containing at least one or more selected nucleotides which preferably have a free 5′ hydroxy function and a protected 3′ hydroxy function or a free 3′ hydroxy function and a protected 5′ hydroxy function. In another embodiment, the kit comprises respective peptides and/or amino acid derivatives with a protected amino group and a free carboxyl group or vice versa. These kits enable easy performance of the method of the present invention in solution or on substrates.

In another embodiment the present invention comprises the use of the methods of the present invention and/or of the above-mentioned kit for the manufacture of oligonucleotides or nucleic acid chips, preferably for the automated manufacture of oligonucleotides or nucleic acid chips.

Further advantages and features of the invention are apparent from the description, examples and the attached figure.

It goes without saying that the above-mentioned features and those to be explained below are not just limited to the combinations mentioned, but rather can also be used in other combinations or alone without leaving the scope of the present invention.

Abbreviations

NPPOC 2-(2-nitrophenyl) propyloxycarbonyl

MeNPPOC 2-(3,4-methylenedioxy-2-nitrophenyl) propyloxycarbonyl

MeNPOC 2-(3,4-methylenedioxy-2-nitrophenyl) oxycarbonyl

DMBOC dimethoxybenzoinyloxycarbonyl

NPES 2-(2-nitrophenyl) ethylsulfonyl

NPPS 2-(2-nitrophenyl) propylsulfonyl

CITX 2-chlorothioxanthone

14DMeOTX 1,4-dirnethoxythioxanthone

EtTX 2-(4-)isopropylthioxanthone

TX thioxanthone

DMAC dimethylacetamide

DMEU 1,3-diemethyl-imidazolidine-2-one

DMF dimethylformamide

DMPU 1,3-dimethyl-3,4,5,6-tetrahydro-2(1H)pyrimidine

DMSO dimethylsulfoxide

MeCN acetonitrile

MeOH methanol

Sulf sulfolane

ThthO tetrahydrothiophene-1-oxide

4NPPOC 2-(4-nitrophenyl)propyloxycarbonyl

4NPPS 2-(4-nnitrophenyl)propylsulfonyl

4NPEOC 2-(4-nitrophenyl)ethyloxycarbonyl

The invention will now be explained by means of the figures below and some non-limiting examples.

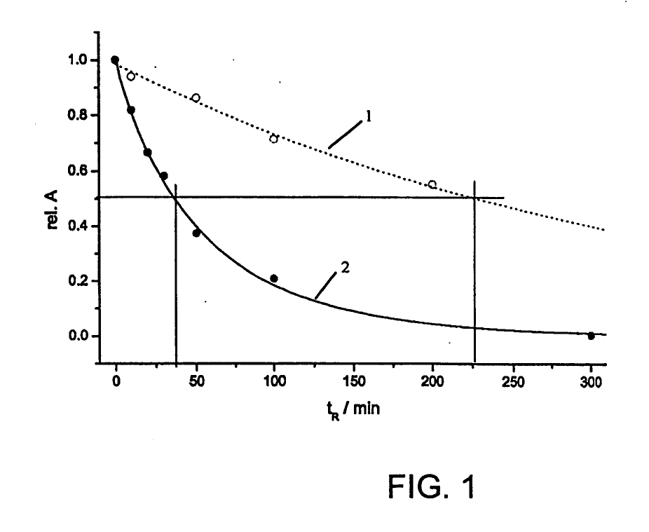

FIG. 1 shows the reaction rate of a cleavage reaction according to an embodiment of a method of the present invention versus a conventional method in solution,

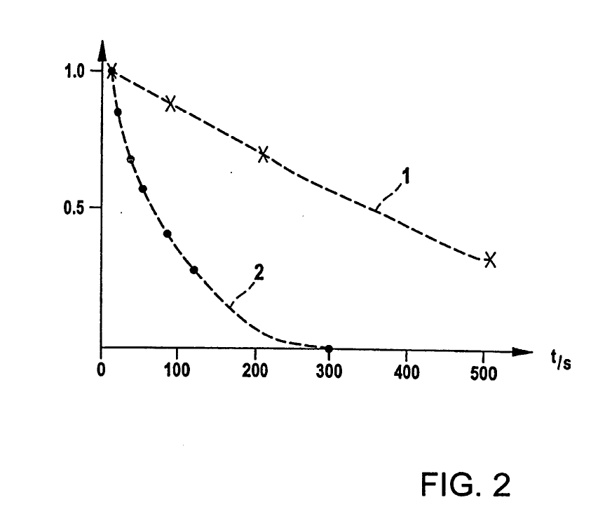

FIG. 2 shows the reaction rate of a cleavage reaction according to a further embodiment of a method of the present invention versus a conventional method in solution,

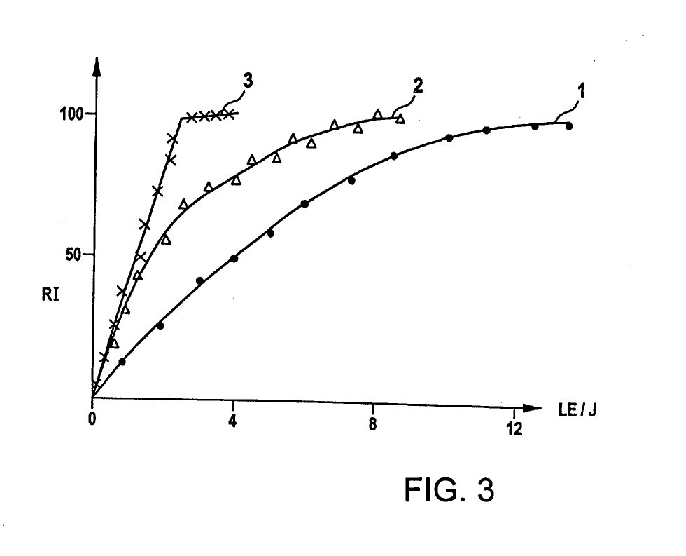

FIG. 3 shows the reaction rate in a further embodiment of a method of the present invention versus a conventional method on a solid substrate.

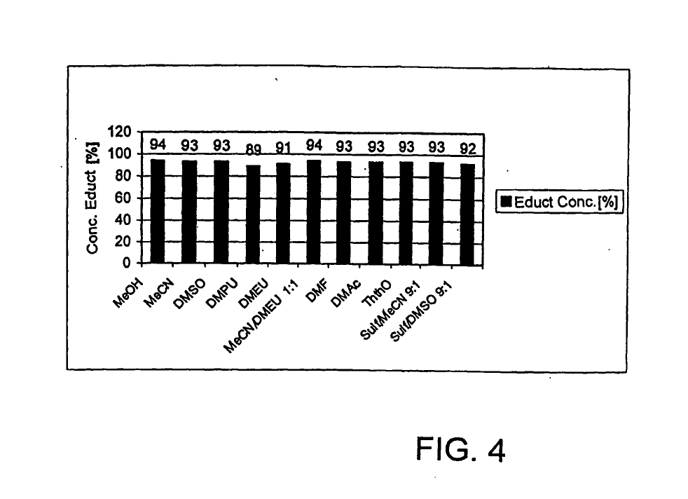

FIG. 4 shows the results of the irradiation of 5′-NPPOC-T without the presence of a sensitizer at wavelengths ≧395 nm for 10 minutes.

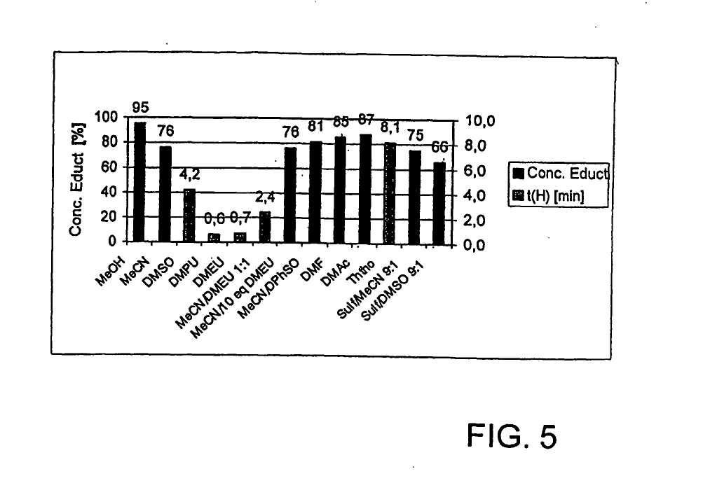

FIG. 5 shows the results of the irradiation of 5′-NPPOC-T in the presence of 10 eq iPrTX in different solvents at wavelengths ≧395 nm. The bars represent either the concentration of starting material after 10 minutes or halflife in minutes.

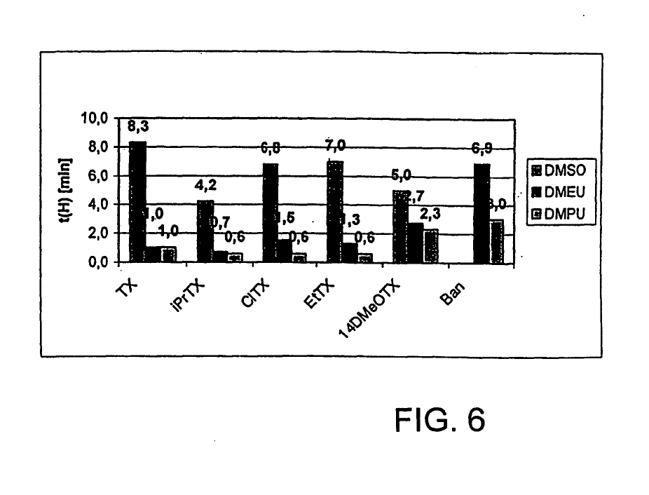

FIG. 6 shows the results of the irradiation of 5′-NPPOC-T in the presence of different sensitizers at wavelengths ≧395 nm, each in different solvents.

The abscissa in FIG. 1 shows the relative concentration of the compound provided with a protective group, as determined by means of HPLC, as a function of the radiation time (tR/min) in minutes (ordinate). Curve 1 shows the irradiation of compound T07 (2-(5-iodo-2-nitrophenyl) propylthymidine-5′-yl carbonate) (0.096 mM) at 366 nm with an intensity of 4.98×10⁻³ W/cm⁻². Curve 2 shows the radiation of compound TOI (2-(5-chloro-2-nitrophenyl) ethylthymidine-5′-yl carbonate) (0,091 mM) at the same wavelength with an intensity of 6.39×10⁻³ W/cm⁻² in the presence of the sensitizing compound thioxanthone (0.113 mM) in acetonitrile saturated with ammonia. Although light intensity is increased by only 25% in the experiment with Curve 2, the reaction rate of the cleavage reaction with the sensitizing compound shown in Curve 2 is six times higher than that of the cleavage reaction without the presence of a sensitizer as shown in Curve 1.

FIG. 2 shows the graphic evaluation of Example 1. The abscissa in FIG. 2 shows the relative concentration of the compound provided with a protective group as determined by means of HPLC as a function of the radiation time (tR/s) in seconds (ordinate). Curve 1 shows the irradiation of compound T02 (2-(2-nitrophenyl) propylthymidine-5 ′-yl carbonate) (0.091 mM) at 366 nm with an intensity of 6.39×10⁻³ W/cm⁻². Curve 2 shows the radiation of compound T02 (2-(2-nitrophenyl) propylthymidine-5′-yl carbonate) (0.091 mM) at the same wavelength with an intensity of 6.39×10⁻³ W/cm⁻² in the presence of the sensitizing compound thioxanthone (0.113 mM) in acetonitrile saturated with ammonia. Although the light intensity in the experiment according to Curve 2 is the same as in the experiment according to Curve 1, the reaction rate of the separation reaction according to Curve 2, i.e. in the presence of a sensitizing compound, is ten times higher than that of the separation reaction without the sensitizing compound according to Curve 1.

The abscissa in FIG. 3 shows the relative intensity RI of the absorbed light energy as a function of the incoming light energy LE in Joule (ordinate) in a method of the present invention on a solid substrate. The method was carried out in accordance with the conditions of Example 2, but the compounds T02 (2-(2-nitrophenyl) propylthymidine-5′-yl carbonate) and 2-(3,4-methylenedioxy-2-nitrophenyl) propylthymidine-5′-yl carbonate) were used instead of the oligomers. Curve 1 shows radiation of the spots with compound T02 without the sensitizing compound; Curve 2 shows radiation of the spots with 2-(3,4-methylenedioxy-2-nitrophenyl) propylthymidine-5′-yl carbonate) without the sensitizing compound and Curve 3 shows radiation of compound T02 with the sensitizing compound. This shows that separation with the sensitizing compound according to Curve 3 was twice as fast as that without the sensitizing compound according to Curve 2 and three times faster than the result shown in Curve 1. Beyond that, it shows that complete separation with the sensitizing compound according to Curve 3 even occurs with lower light energy than without the sensitizing compound as shown in Curves 2 and 1.

A non-limiting selection of labile reactive groups of the present invention, i.e. so called “protective groups”, are mentioned in the following. The compounds were prepared in accordance with syntheses known to those skilled in the art.

Labile, reactive protective groups according to the present invention or molecules containing said protective groups are for example:
2-(2-chloro-6-nitrophenyl) ethanol (L01), 2-(2-nitrophenyl) propanol (L02), 2-(2-nitrophenyl) ethanol (L03), 2-(4-bromo-2-nitrophenyl) propanol (L04), 2-(5-chloro-2-nitrophenyl) propanol (L05), 2-(5-bromo-2-nitrophenyl) propanol (L06), 2-(5-iodo-2-nitrophenyl) propanol (L07), 2-(2-chloro-6-nitrophenyl) ethyl methyl carbonate (M01), methyl-2-(2-nitrophenyl) propyl carbonate (M02), methyl-2-(2-nitrophenyl) ethyl carbonate (M03),2-(4-bromo-2-nitrophenyl) propyl methyl carbonate (M04), 2-(5-chloro-2-nitrophenyl) propyl methyl carbonate (M05), 2-(5-bromo-2-nitrophenyl) propyl methyl carbonate (M06), 2-(5-iodo-2-nitrophenyl) propyl methyl carbonate (M07), 2-(2-chloro-6-nitrophenyl) ethyl thymidine-5′-yl carbonate (T01), 2-(5-nitrophenyl) propyl thymidine-5′-yl carbonate (T02), 2-(4-bromo-2-nitrophenyl) propyl thymidine-5′-yl carbonate (T04),2-(5-chloro-2-nitrophenyl) propyl thymidine-5′-yl carbonate (T05), 2-(5-bromo-2-nitrophenyl) propyl thymidine-5′-yl carbonate (T06), 2-(5-iodo-2-nitrophenyl) propyl thymidine-5′-yl carbonate (T07)

It was found that chemical compounds according to the present invention that are suitable for carrying out the methods of the present invention have the following non-limiting characteristics:

The chemical compound of the present invention preferably absorbs radiation of longer wavelengths than the labile protective group itself, i.e. its singlet (S₁) state is below the singlet (S₁) state of the protective group, most preferably with a clean separation of the two absorption bands of the chemical compound and of the labile protective group.

Furthermore, the chemical compound's absorption coefficient in its absorption band with the longest wavelengths is as high as possible.

Its triplet state is above the triplet state of the labile protective group or similar to it energetically. Therefore, the singlet-triplet energy gap of the sensitizing compound is preferably smaller than that of the labile protective group. When using nitrophenylchromophores in the labile protective group, this energy gap is generally 130 kJ/mol, so that a variety of sensitizing compounds can be used in the present invention.

Furthermore, the chemical compound has a high triplet formation quantum yield Φ_{T} which is incorporated linearly as a factor in sensitization efficiency.

Furthermore, the triplet lifetime of the chemical compound is as long as possible to ensure high efficiency of energy transfer. It was found for a quantitative intermolecular energy transfer with an advantageous energy situation of T₁, that a lifetime of more than 0.6 μs is sufficient, whereby a lifetime of more than 1 μs is preferred and a lifetime of more than 20 μs is especially preferred.

In especially advantageous embodiments of the invention the quantum yield Φ of the chemical reaction according to one of the above methods of the present invention when separating the labile functional group is greater than 0.5.

Examples of compounds of this kind according to the present invention are listed in Table 1 below.

TABLE 1
Chemical compounds (“sensitizing compounds”) of the present invention with a
higher triplet state than a photolabile protective group of molecules of
the present invention

| | E(S₁) | | εₘₐₓ | E(T₁) | | |
|---|---|---|---|---|---|---|
| Compound | kJ/mol | | M⁻¹ × cm⁻¹ | kJ/mol | φ_{T} | τ_{T} |
| Acridone | n/b | 304 | 7580 | 244 | 0.99 | 20 μs |
| 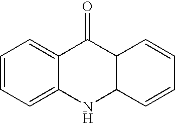 | p/nb | 290 | (399 nm) | 252 | <0.03⁽²⁾ | 9.2 μs |
| Xanthone | n/b | 324 | 10000 | 310 | | 20 ns |
| | | | (330 nm) | | | |
| 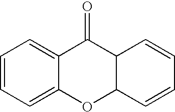 | p/nb | | 6200 (335 nm) | 310 | | 17.9 μs |
| Thioxanthone | p | | 6800 | 265 | <0.88 | 73 μs |
| 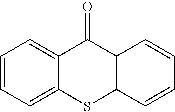 | p/nb | | (380 nm) | | | 95 μs |
| 2-acetyl-naphthalene | b | | 1000 | 249 | 8.84 | 300 μs |
| 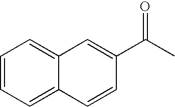 | p | 325 | (342 nm) | 249 | | |
| For comparison: | n | 372 | 272 | 243 | 0.67 | 0.8 ns |
| Nitrobenzene | p | | (365 nm) | 252 | | |
| 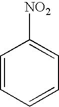 | | | | | | |

The energy (E) of the singlet and triplet states is expressed in kJ/mol. The absorption coefficient E is expressed in M⁻¹×cm⁻¹ with the respective wavelength. n means a non-polar solvent, p a polar solvent and b a benzene-like solvent.

τ is the lifetime of the triplet state expressed in μs.

Further compounds of the present invention comprise, for example, but are not limited to N-methylacridone, alkylxanthones and alkylthioxanthones like for example 2-ethyl-thioxanthone, 2-isopropyl-thioxanthone, 1,4-dimethoxythioxanthone, 2-anilinonaphthalene, naphtho-[1,2-c][1,2,5]thiadiazole, benzo-[b]fluorene, 5,7-dimethoxy-3-thionylcoumarine, 1,2-cycloheptanedione, 3-acetyl-6-bromocoumarine, 2-bromo-9-acridinone, 4,4′-dibenzylbiphenyl, 2,6-dithiocaffeine, 1,4-dibromonaphthalene, dibenzo-[fg,op]-naphtalene, 10-phenyl-9-acridinone, 2-methyl-5-nitroimidazole-1-ethanol, 1-(2-naphthoyl) aziridine, 9-(2-naphthoyl) carbazole, 4,6′-diamino-2-phenylbenzooxazole, p-thiophenyl, 3-acetylphenanthrene, dinaphtho-(1,2-b:2′, 1′-]thiophene, (E)-piperylene, β-methyl-(E)-styrene, 2-phenyl-benzothiazole, chinoxaline, 9,9′-biphenantryl, naphtho-[l,2-c][1,2,5]oxabiazol, phenothiazine, 2-ethoxynaphthol, 9-phenyl-9-stibafluorene, 9,10-antrachinone, 4,4 ′-dichlorodiphenyl.

Further compounds are listed in the book by S. L. Murov, I. Carmichael and G. L. Hug, Handbook of Photochemistry, Marcel Dekker, Inc., New York, 1993, whose disclosure is incorporated herein by reference.

General Remarks

Experimental Conditions:

The term “common conditions known to those skilled in the art” as it is used herein is described in U.S. Pat. No. 5,763,599 or DE 4444956 among other places.

UV/VIS absorption measurements were performed using a Lambda 18 UV-VIS spectrometer (Perkin-Elmer) with UV Winlab software; fluorescence measurements were performed using an LS 50 luminescence spectrometer (Perkin-Elmer) with FL Winlab software.

The radiation equipment consisted in the case of a mercury lamp of a high-pressure mercury lamp (200 W), an IR filter (optical path length 5 cm, filled with 0.3 M CuSO₄ solution in water), a focusing lens, an electronically controlled shutter, a 366 nm interference filter (Schott) and a cell holder for cells with temperature adjustment (Hellma QS, 1 cm). In the case of a Xenon lamp, the irradiation apparatus comprises a Xenon lamp (100W OSRAM), a filter with a wavelength of 400 μm and an electronic shutter for the control of the exact irradiation times. The sample holder was adjusted on 22° C.

The HPLC examinations were performed using a Merck-Hitachi device consisting of an L-7100 pump, an L-7200 autosampler, an L-7450A UV diode array detector and an L-7000 interface. LiChrospher 100 PR-18 (5 μm) by Merck was used for the column and HSM manager and a Compaq computer were used for control.

The absorption maxima of the labile functional groups or, as applicable, the photolabile protective groups and the sensitizing compound were determined based on the wavelength of the electromagnetic radiation used for activation applying methods known to those skilled in the art such as UV/VIS absorption, etc. The absorption maxima of the labile functional group(s) were measured both on the molecule containing the labile functional group(s) (such as NPPOC-protected thymidine) and on the starting compound for introduction of the labile functional group, for example, the respective alcohol or halogenide (such as NPPOH), in the molecule itself. Here, though, the respective values obtained did not differ substantially.

For the examples 2 to 5, 0.1 micromolar solutions of the 5′-O-photolabile protected nucleosides to be irradiated have been prepared. Irradiation in the presence of the sensitizer, the desired amount of sensitizers was added before.

Irradiation with the Xenon lamp was carried out in quartz cell (3.5 ml) with each 3 ml of the solution to be irradiated. For each measurement point (generally after 1 min., 5 min. and 10 min. irradiation time) a different cell was used. In the case of a combination of MeOH/MeCN, 10 μl of the irradiated solution were injected in the HPLC apparatus. With the other solvents, the solution to be examined was dilyuted with acetonitrile (1:2) and 30 μm of the solution were analyzed.

The chromatograms obtained, allow the detection and determination of the decrease of the educt (5′-O-protected nucleoside) and the increase of the product (5′-O-deprotected nucleoside). The determinations are based on the surface of the single peaks. As a reference sample, the solution of the nucleoside to be irradiated at a time 0 min. (that is before irradiation) was injected and the surface of the peaks obtained was considered as 100% educt. In the same manner, a pure product was measured. The peak surface of a 0.1 micromolar solution of a pure product was set to 100%. The areas of the product and educt peaks for each irradiation times were correlated to the standards and expressed as “concentration” (%).

The single measurement points were connected and the half lifetime t_{H} was calculated from the part of the graph which corresponds to 50% concentration of the educt. The concentration of thymidine at the half lifetime was also calculated from this point. If at the longest irradiation time of 10 min., the half lifetime was not reached, the concentration of the educt and the product, that is thymidine, is indicated.

In the case of the DMPU and DMEU as solvents, baseline separation by HPLC of those solvents and the deprotected nucleoside was not possible in each case.

### EXAMPLES

### Example 1

Cleavage Reaction of a Labile Functional Group From a Molecule in Solution Using the Method of the Present Invention

3 ml of a solution of thymidine T02 (Table 2) (0.091 mM) and thioxanthone in acetonitrile (0.113 mM) were pipetted into a cell and gassed with ammonia for approx. 15 minutes by passing the gas through the solution. The solution was exposed to light of a wavelength of 366 nm for varying periods of time. Absorption spectra were measured prior to and after radiation. The same reaction was carried out using thymidine T02 and without adding a sensitizing compound.

The results of Example 1 are explained in FIG. 2 and shown in a diagram.

The solution was then flushed with nitrogen (saturated with acetonitrile) for approx. 15 minutes. An absorption spectrum was measured again after nitrogen flushing and the solution was then separated into its components in the HPLC. These were characterized by a UV diode array detector. It was found that the deprotection reaction with the sensitizing compound was almost complete (99%) and no side products apart from the starting product and the desired end product in addition to the separated protective group were detected. The deprotection reaction without an addition of the sensitizing compound, however, was only 75% complete.

### Example 2

Cleavage of 5′-NPPOCT

1. Irradiation of the Sensitizer Concentration During the Cleavage Reaction

The sensitizer concentration (based on the nucleoside to be irradiated) was varied between 2%, 1 eq., 10 eq. and 100 eq.

Upon irradiation of 5′-NPPOC-T in DMSO with iPrTX it was found that a sensitizer concentration of 10 eq. yields the best results. At least a tenfold access of sensitizer has to be used in order to give a successful cleavage reaction. In most solvents tested, like MeOH, MeCN, DMPU, the optimum value is around 10 eq.

Therefore, most of the following tests have been performed with a concentration of 10 eq. of sensitizer.

2. Variation of Solvents and Sensitizers

For the cleavage reaction of the NPPOC protected group different solvents have been examined:

Methanol (MeOH), acetonitrile (MeCN), dimethylsulfoxide (DMSO), 1,3-dimethylimidazolidine-2-one (DMEU), 1,3-dimethyl-3,4,5,6-tetrahydro-2(1H)pyrimidone (DMPU), diphenylsulfoxide (DPhSO) in acetonitrile, dimethylfornamide (DMF), dimethylacetamide (DMAc), tetrahydrothiophene-1-oxide (ThthO), sulfolane (sulf)/acetonitrile 9: 1, sulfolane/DMSO 9:1.

The following sensitizers have been tested:

2-(4-)isopropylthioxanthone (iPrTX), thioxanthone (TX), 2-chlorothioxanthone (CITX), 1,4-dimethoxythioxanthone (14DMeOTX), 2-ethyl-thioxanthone (EtTX).

3. Irradiation of 5′-NPPOC-T Without Sensitizer

As shown in FIG. 4, upon irradiation over 10 min. without the use of a sensitizer a cleavage of NPPOC protective group did not occur in considerable amounts. After 10 min. of irradiation, approximately at least 90% of the educt are still present. This effect was found in a large variety of solvents as shown in FIG. 4.

4. Irradiation of Sensitizers

To test the stability of sensitizers upon irradiation, a 1 μl sensitizer solution was irradiated during 10 min. at 400 nm. whereas the sensitizers are stable in acetonitrile and dimethylsulfoxide, they degrade in DMPU and DMEU over 10 min. up to 60%. Also, a mixture of MeCN/DMEU showed considerable degradation. However, the degradation in this solvent mixture is considerably slower as in pure DMEU.

5. Irradiation of 5′-NPPOC-T with 10 eq. iPrTX

As shown in FIG. 5, the irradiation of 5′-NPPOC-t with 10 eq. iPrTX was investigated in different solvents.

Irradiation was carried out with a 400 nm Xenon lamp in different solvents as indicated in FIG. 5. In the majority of the solvents (MeOH, MeCN, DMSO, DMAC etc.) no cleavage of the NPPOC protective group was found. However, in DMSO, DMPU, DMEU, DMEU/MeCN1:1 and ThthO the cleavage of NPPOC protective groups speeds up considerably. In the solvents DMPU and DMEU the overall cleavage rate of NPPOC lies below 1 min.

As can be seen from FIG. 5, methanol shows only a slight or no cleavage reaction at all, whereas DMSO, DMEU and DMPU proved to be the preferred solvents.

6. Irradiation of 5′-NPPOC-T in Different Solvents with Different Sensitizers (FIG. 6)

Other sensitizers as iPrTX have a similar behaviour. Moreover, in MeOH even with a variety of sensitizers (TX, iPrTX, CITX, ETX, Ban, 14DMeOTX) no cleavage of NPPOC was observed. In DMSO, all sensitizers reach the half lifetime during irradiation time in DMEU and DMPU, the half lifetime is even in the range of 1 min. or less. This is examplified in FIG. 6 where 5′-NPPOC-t has been irradiated at 400 nm with a Xenon lamp with 10 eq. sensitizers each in different solvents.

### Example 3

Irradiation of 5′-NPEOC-T

The protective group NPEOC which is stable at 400 nm in DMSO and DMEU can be cleaved upon addition of 10 eq. iPrTX. Without addition of iPrTX, no cleavage of NPEOC is observed.

5′-NPEOC-T was irradiated at 400 nm with a Xenon lamp with and without 10 eq. iPrTX in DMSO and DMEU. The half lifetime of the cleavage of NPEOC in DMEU with 10 eq. iPrTX was 2.8 min. Without the addition of the sensitizer iPrTX, NPEOC was not cleaved and 100% of educt were recovered.

### Example 4

Irradiation of 5′-4NPPOC-T at 400 nm

The protective group for 4NPPOC is stable upon irradiation at each 365 and 400 nm. Therefore, irradiation experiments with and without the addition of 10 eq. of iPrTX were carried out. Besides 5′-4NPPOC-T, also 5′-4NPPOC-dG(iBu) was tested. The addition of a sensitizer iPrTX in DMEU and DMPU as solvent lead to a protective group cleavage. It was observed, that cleavage of 2NPPOC-T in DMEU is approximately 4 times faster as the cleavage of the 4NPPOC-T. However, in DMPU cleavage of both protective groups occurs with approximately the same reaction rate. Upon addition of TX instead of iPrTX, 2NPPOC has a three times higher cleavage rate than 4NPPOC in DMPU.

### Example 5

Irradiation of 4NPES-T and 4NPPS-T at 400 nm

Irradiation of NPES-T and NPPS-T in acetonitrile and DMEU show that cleavage of the 4NPES and 4NPPS group did only take place in DMEU upon addition of 10 eq. of iPrTX. Irradiation was carried out at 400 nm with a Xenon lamp. The half lifetimes of 4NPES-T 2.5 min. and the half lifetime of 4NPPS-T was 1.1 min. Both protective groups are stable if irradiated at 365 or 400 nm without sensitizer.

### Comparative Example

For comparative reasons only, cleavage reactions were carried out with 5′-NPPOC-T in the presence of 10 eq. of benzoic acid, derivatives, namely benzoic acid and the potassium salt of benzoic acid (PHCOOH and PHCOOK). The results as shown in table 4:

TABLE 4

| | Half-lifetime | | |
|---|---|---|---|
| | without | | |
| | “benzoic | Half-lifetime 10 eq | Half-lifetime 0 eq |
| Solvent | stabilizer” | PHCOOH | PHCOOK |
| MeCN | 3.4 | 3.6 | 4.4 |
| DMSO | 4.0 | 3.0 | 3.7 |
| MeOH/5% | 3.9 | 3.4 | 4.0 |
| H₂O | | | |

| | Product | | |
|---|---|---|---|
| | yield (%) | | |
| | without | | |
| | “benzoic | Product yield (%) | Product yield (%) |
| | stabilizer” | 10 eq PHCOOH | 10 eq PHCOOK |
| MeCN | 33.0 | 21 | 48 |
| MeOH/5% | 39.0 | 20 | 40 |
| H₂O | | | |

As is apparent from table 4, the cleavage takes place even without the addition of benzoic acid derivative. The addition of benzoic acid leads even to a decrease in yield as compared to the reaction without benzoic acid. The addition of PhCOOK leads also to very modest yields.

This result shows clearly that benzoic acid and its derivatives cannot be considered as a “sensitizer” as defined by the present invention.

### Example 6

Manufacture of DNA Chips Using the Method of the Present Invention

The deprotection reaction was performed in an MAS 2.0 or an MAS 3.0 by Nimblegen Systems, Madison under standard test conditions for DNA chip syntheses. The design of the DNA chips to be produced had a standard array usually used for quality control tests.

The typical density was in a range of several 10,000 to several 100,000 oligonucleotides (oligomers), primarily present as 18-23mers. The size or surface area of a single synthesis spot was 35 μm×35 μm. The spot consisted of an image (1:1) of 4 micromirrors (Texas Instrument Digital Light Processor) arranged in squares (each with an edge length of 16 μm×16 μm) that were arranged at a distance of 1 μm from each other.

0.01 weight percent thioxanthone were used as a sensitizing compound in relation to the solvent used (DMSO). This resulted in reduction of the light dose all the way to complete separation of the protective group from 7.5 W/cm² without the sensitizing molecule to a value of 3 W/cm², with an effective lamp capacity of approx. 0.2-0.6 W/cm². The lamp capacity depends on the MAS type and is determined during radiation.

| | | |
|---|---|---|
| MAS type 2.0: | 1000 Watt | Hg lamp |
| MAS type 3.0: | 200 Watt | Hg lamp |

Duration of the deprotection reaction:

| | Lamp capacity | |
|---|---|---|
| | W/cm² | Duration (s) |
| Without thioxanthone | 0.2 | 37.5 |
| Without thioxanthone | 0.6 | 12.5 |
| With thioxanthone (0.01 weight percent) | 0.2 | 15 |
| With thioxanthone (0.01 weight percent) | 0.6 | 5 |

As seen in the above, adding thioxanthone as a sensitizing compound leads to a marked increase in the rate of the separation reaction, even when using low lamp capacities.

1. A method for the cleavage of labile functional groups from molecules by exposure to electromagnetic radiation which comprises the following steps:
a) Selecting a suitable chemical compound whose triplet state is energetically higher than or very similar to the triplet state of the labile functional group;
b) Bringing the suitable chemical compound into contact with the molecules comprising the labile functional groups;
c) Exposing the compound to electromagnetic radiation, with the sequence of steps b) and c) being arbitrary;
characterized in that the labile functional group and the suitable chemical compound have different absorption maxima for electromagnetic radiation.

2. A method according to claim 1 characterized in that step b) is carried out prior to step c).

3. A method according to claim 1 characterized in that step c) is carried out prior to step b).

4. A method according to claim 1 characterized in that step c) and step b) are carried out simultaneously.

5. A method according to of claim 1 characterized in that the electromagnetic radiation has a wavelength which is in the range of the absorption maximum of the suitable chemical compound.

6. A method according to claim 5 characterized in that the electromagnetic radiation is in the wavelength range of UV/VIS radiation.

7. A method according to claim 6 characterized in that the labile group is photolabile.

8. A method according to claim 1 or 5 characterized in that a singlet state of the chemical compound is energetically lower than the singlet state of the labile functional group.

9. A method according to claim 8 characterized in that the triplet-singlet energy gap of the chemical compound is smaller than the triplet-singlet energy gap of the labile functional group.

10. A method according to claim 1 or 5 characterized in that the absorption of the longest wavelength electronic absorption band of the electromagnetic radiation of the chemical compound consists of wavelengths longer than 350 nm.

11. A method according to claim 1 or 5 characterized in that the absorption bands of the chemical compound and of the labile functional group are separated.

12. The use of the method according to claim 1 or 5 to manufacture of spatially addressed molecular libraries.

13. A method of manufacturing spatially addressed molecular libraries containing biomolecules by spatially addressed, light-controlled synthesis from single biomolecule building blocks on solid substrates which comprises the following steps:
a) Reaction of the unprotected terminal 3′ or 5′ hydroxy group of a nucleoside and/or nucleotide or a nucleic acid analogue or the terminal amino group or carboxy group of a respective peptide arranged on the solid substrate under common conditions with a photolabile protective group or reaction of an —OH group, a substituted or unsubstituted amino group or carboxy group with a building block comprising a photolabile protective group, and, if necessary, purification of the reaction product;
b) Application of a suitable chemical compound whose triplet state is energetically higher than or very similar to that of the photolabile protective group on the surface of the substrate which exhibits the nucleotides and/or nucleosides modified in step a) and/or correspondingly modified peptides or proteins;
c) Spatially selective irradiation of the substrate surface treated in step b) with electromagnetic radiation in the UV/VIS range; and,
d) Reaction with a nucleoside and/or nucleotide in which a free 5′ or 3′ OH group is protected by a photolabile group and/or with a respective peptide which is protected at the amino group or carboxy group by a photolabile group;
characterized in that the photolabile protective group and the suitable chemical compound have different absorption maxima for electromagnetic radiation in the UV/VIS range.

14. A method according to claim 13 characterized in that step b) is carried out prior to step c).

15. A method according to claim 14 characterized in that step c) is carried out prior to step b).

16. A method according to claim 15 characterized in that step c) and step b) are carried out simultaneously.

17. A method according to claim 13 characterized in that the UV/VIS radiation used has a wavelength which is in the range of the absorption maximum of the suitable chemical compound.

18. A method according to claim 13 characterized in that the singlet state of the chemical compound is energetically lower than the singlet state of the photolabile protective group.

19. A method according to claim 18 characterized in that the triplet-singlet energy gap of the chemical compound is smaller than the triplet-singlet energy gap of the photolabile protective group.

20. A method according to claim 19 characterized in that the absorption of the longest wavelength absorption band of the electromagnetic radiation of the chemical compound consists of wavelengths longer than 350 nm.

21. A chemical composition comprising a molecule with a labile functional group and a chemical compound whose triplet state is energetically higher than or very similar to that of the labile functional group characterized in that the labile functional group and the suitable chemical compound have different absorption maxima for electromagnetic radiation.

22. A chemical composition according to claim 21 characterized in that the labile functional group is a photolabile group.

23. A chemical composition according to claim 22 characterized in that the singlet state of the chemical compound is energetically lower than the singlet state of the photolabile group.

24. A chemical composition according to claim 23 characterized in that the triplet-singlet energy gap of the chemical compound is smaller than the triplet-singlet energy gap of the photolabile group.

25. A chemical composition according to claim 21 or 24 characterized in that the photolabile group is selected from the group consisting of NPPOC, MeNPOC, MPES-NPPS, MeNPPOC, DMBOC and their substituted derivatives, substituted and unsubstituted, condensed and uncondensed 2-(nitroaryl) ethoxycarbonyl or thiocarbonyl compounds, substituted and unsubstituted, condensed and uncondensed 2 nitrobenzyl, 2-nitrobenzyloxycarbonyl or thiocarbonyl compounds, substituted and unsubstituted, condensed and uncondensed 2-(nitroheterocycloaryl) ethoxycarbonyl or thiocarbonyl compounds and substituted and unsubstituted, condensed and uncondensed 2-(nitroheterocycloalkyl) ethoxycarbonyl/thiocarbonyl compounds, substituted and unsubstituted 2-nitro-N-methylanilinecarbonyl or thiocarbonyl derivatives.

26. A chemical composition according to claim 21 or 24 characterized in that the chemical compound contains the structural motive 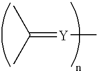
wherein Y=O, S, N, Se or Te, n=1 or 2, C is a component of an aromatic, heteroaromatic or condensed aromatic or heteroaromatic system, and wherein, in the case that n=2, the aromatic, heteroaromatic or condensed aromatic or heteroaromatic system can be the same or different.

27. A method comprising using a chemical composition according to claim 21 or 24 for the manufacture of DNA chips.

28. A kit comprising a chemical compound according claim 21 or 24.

29. A kit comprising at least a portion of the reagents and/or solvents and/or an instruction for performing a method according to one of the claims 1, 5, 13 or 16 to 20 in a spatial unit.

30. A method comprising using the method according to one of the claims 13 or 16 to 20 for the manufacture of oligonucleotides, polypeptides or nucleic acid or peptide chips.

31. A method comprising using the method according to one of the claims 1 or 5 for the manufacture of spatially addressed molecular libraries and/or polymers.

32. The method of claim 13 wherein the method further comprises repeating steps b) to d).

33. A method comprising using a chemical composition according to claim 25 for the manufacture of DNA chips.

34. A method comprising using a chemical composition according to claim 26 for the manufacture of DNA chips.

35. A kit comprising a chemical compound according to claim 25.

36. A kit comprising a chemical compound according to claim 26.

37. A kit comprising all of the reagents and solvents, and an instruction for performing a method according to one of the claims 1, 5, 13 or 16 to 20 in a spatial unit.

38. A kit comprising at least a portion of the reagents and/or solvents and/or an instruction for performing a method according to claim 8 in a spatial unit.

39. A kit comprising at least a portion of the reagents and/or solvents and/or an instruction for performing a method according to claim 10 in a spatial unit.

40. A kit comprising at least a portion of the reagents and/or solvents and/or an instruction for performing a method according to claim 11 in a spatial unit.

41. A kit comprising at least a portion of the reagents and/or solvents and/or an instruction for performing a method according to claim 12 in a spatial unit.

42. A method comprising using a kit according to claim 28 for the manufacture of oligonucleotides, polypeptides or nucleic acid or peptide chips.

43. A method comprising using a kit according to claim 29 for the manufacture of oligonucleotides, polypeptides or nucleic acid or peptide chips.

44. A method comprising using the method according to claim 8 for the manufacture of spatially addressed molecular libraries and/or polymers.

45. A method comprising using the method according to claim 10 for the manufacture of spatially addressed molecular libraries and/or polymers.

46. A method comprising using the method according to claim 11 for the manufacture of spatially addressed molecular libraries and/or polymers.

47. A method comprising using the method according to claim 12 for the manufacture of spatially addressed molecular libraries and/or polymers.

48. A method comprising using a kit according to claim 28 for the manufacture of spatially addressed molecular libraries and/or polymers.

49. A method comprising using a kit according to claim 29 for the manufacture of spatially addressed molecular libraries and/or polymers.
